(19) United States
(12) Patent Application Publication
(10) Pub. No.: US 2002/0131900 A1
(43) Pub. Date: Sep. 19, 2002

(54) Sensor comprising a hydrophilic matrix material

(76) Inventor: Niels-Henrik Jensen, Holte (DK)

Correspondence Address: Kevin C. Hooper, Bryan Cave llp, 245 Park Avenue, New York, NY, 10167, US

(21) Appl. No.: 10/043,062

(22) Filed: Jan. 8, 2002

Related U.S. Application Data
(63) Continuation of application No. PCT/DK00/00365, filed on Jul. 5, 2000.

(30) Foreign Application Priority Data
Jul. 8, 1999 (DK) PA 1999 00986

(51) Int. Cl. G01N 21/00

(52) U.S. Cl. 422/82.05; 422/82.08; 422/52; 436/164; 436/165; 436/172

(57) ABSTRACT

A sensor for measuring an analyte in a biological sample, the sensor including a hydrophilic and/or water-swellable polymeric matrix material at least one portion of which includes an analyte-sensitive indicator compound and a cyclic compound which has a three-dimensional structure forming a hydrophobic inner cavity and a hydrophilic exterior surface.

### FIELD OF INVENTION

The present invention relates to a sensor for measuring an analyte in a sample, a membrane comprising a matrix material and an indicator compound for use in the sensor, a method of improving the stability of the indicator compound in the matrix, and the use of a compound associated with the indicator compound in the method.

### BACKGROUND OF THE INVENTION

Sensors for measuring the presence and quantity of analytes in biological samples and including a membrane adapted for inclusion of indicator compounds that react with analytes to produce a detectable signal have been known for several years. A general description of sensors of this type appears from E. A. H. Hall, “Overview of Biosensors”, in Biosensors and Chemical Sensors: Optimizing Performance through Polymeric Materials, P. G. Edelmann and J. Wang (Eds.), American Chemical Society, Washington D.C., 1992, pp. 1-14; and J. S. Schultz and R. F. Taylor, “Introduction to chemical and biological sensors”, in Handbook of Chemical and Biological Sensors, R. F. Taylor and J. S. Schultz (Eds.), Institute of Physics Publishing, Bristol and Philadelphia, 1996, pp. 1-9.

A method of determining the content of an analyte in sample of whole blood is described in U.S. Pat. No. 5,288,646. The method employs a membrane of a hydrophilic polymer material such as cellulose which includes an indicator dye immobilised thereto.

### SUMMARY OF THE INVENTION

A disadvantage of the known sensors comprising a hydrophilic matrix material to which a hydrophobic indicator compound is imnmobilised is that the indicator compound tends to aggregate in the-presence of moisture to form e.g. dimeric structures. Moisture induced aggregation of the matrix-bound indicator compound will change the physical-chemical characteristics of the indicator compound. These changes will have adverse effects on the accuracy of the readings obtained when the sensor is used in connection with automated analysers to determine the presence and/or quantity of an analyte in a sample. In order to avoid such aggregation, it is necessary to provide storage facilities for such matrices or instruments containing them in which humidity is strictly controlled, thus adding to the expense of using this type of sensor. An object of the present invention is to provide a sensor comprising a hydrophilic matrix including an immobilised hydrophobic indicator compound which does not form moisture induced aggregates in the matrix and which consequently has improved storage stability under conditions where humidity is not strictly controlled.

It has surprisingly been found possible to reduce the tendency of the indicator compound to aggregate in the matrix by including a cyclic compound which contains a hydrophilic moiety as well as a hydrophobic moiety in the matrix material in such a way that the cyclic compound protects the indicator compound from aggregating in the matrix in the presence of moisture, but on the other hand does not block the reaction of the indicator compound with the analyte.

Accordingly, the present invention relates to a sensor for measuring an analyte in a biological sample, the sensor comprising a hydrophilic and/or water-swellable matrix material at least one portion of which includes an analyte-sensitive indicator compound and a cyclic compound which has a three-dimensional structure forming a hydrophobic inner cavity and a hydrophilic exterior surface.

In the present context, the term “matrix” is intended to indicate a polymeric structure which is capable of incorporating or attaching other molecules, in particular indicator compounds. The term “hydrophilic” is intended to indicate that the matrix includes a substance which is water-soluble or capable of attracting water. The term “water-swellable” is intended to indicate the ability of the matrix to be hydrated in the presence of moisture. The term “indicator compound” is intended to indicate a compound which is capable of reacting with the analyte, either directly or indirectly, to produce a detectable signal, for instance an optical signal. The indicator compound may be immobilised within the matrix material provided that it is available for reaction with the analyte, in which case the matrix should be one which is permeable to the analyte, or it may be immobilised on the surface of the matrix facing the biological sample, or both. The cyclic compound is generally one which forms a cylindrical structure. The term “hydrophobic inner cavity” is intended to indicate that the inside portion of the cylinder is predominantly hydrophobic in nature and therefore capable of hosting a hydrophobic moiety of the indicator compound. The term “hydrophilic exterior surface” is intended to indicate that the outside portion of the cylinder is predominantly hydrophilic in nature and is therefore compatible with the hydrophilic matrix material as well as with the water taken up by the matrix.

In another aspect, the present invention relates to a membrane adapted for use in a device for measuring an analyte in a biological sample, the membrane comprising a hydrophilic and/or water-swellable polymeric matrix material which at least in one portion includes an analyte sensitive indicator compound and a cyclic compound which has a three-dimensional structure forming a hydrophobic inner cavity and a hydrophilic exterior surface.

In a further aspect, the invention relates to a method of improving the properties of a membrane for use in a sensor, the membrane comprising a hydrophilic and/or water-swellable polymeric matrix material at least one portion of which includes analyte-sensitive indicator compound, the method comprising contacting the indicator compound with a cyclic compound which has a three-dimensional structure forming a hydrophobic inner cavity and a hydrophilic exterior surface for a sufficient period of time to form an association of the indicator compound with the cyclic compound.

### DETAILED DESCRIPTION OF THE INVENTION

In one embodiment of the invention, the indicator compound may be immobilised in the matrix material and the cyclic compound may be associated with the indicator compound. The term “associated with” is intended to indicate that a molecule of the indicator compound combines with a molecule of the cyclic compound due to the hydrophobic forces between a hydrophobic moiety of the indicator compound and the hydrophobic inner cavity of the cyclic compound. Alternatively, the cyclic compound may be immobilised in the matrix material and the indicator compound may be associated with the cyclic compound.

The matrix material preferably forms a layer which may constitute or be incorporated in a membrane of the sensor. It is envisaged that several different types of sensors may be modified according to the present invention. A general description of sensors suitable for modification appears from E. A. H. Hall, “Overview of Biosensors”, in Biosensors and Chemical Sensors. Optimizing Performance through Polymeric Materials, P. G. Edelmann and J. Wang (Eds.), American Chemical Society, Washington D.C., 1992, pp. 1-14; and J. S. Schultz and R. F. Taylor, “Introduction to chemical and biological sensors”, in Handbook of Chemical and Biological Sensors, R. F. Taylor and J. S. Schultz (Eds.), Institute of Physics Publishing, Bristol and Philadelphia, 1996, pp. 1-9.

While a variety of sensors may be modified according to the invention, preferred sensors are optical sensors, e.g. sensors producing a colour response to a particular analyte which may either consist in a change in colour or in colour intensity, or producing a fluorescent or luminescent response in the presence of a particular analyte.

The sensor may be a so-called dipping sensor, usually rod-shaped, the analyte-sensitive area of which is located at one end of the sensor at a surface which is in contact with the biological sample. An example of such a sensor is described in WO 97/36994 which is hereby incorporated by reference. The sensor may also be part of a measuring cuvette designed to contain a sample. In case of the latter, the sensor will most usually form part of a wall of the measuring cuvette or alternatively have the form of a membrane situated in a chamber of the measuring cuvette. The measuring cuvette may be designed for disposable use or may be provided as an integral component of an analyser for the determination of an analyte in the sample. An example of such an analyser is described in U.S. Pat. No. 5,288,646 which is hereby incorporated by reference.

A suitable thickness of a membrane incorporating the matrix is in the range of 1-50 μm, such as 5-20 μm, in particular about 8 μm.

The polymeric matrix material may comprise an organic or inorganic polymer, or mixture of polymers. Preferably, the polymer is an organic polymer, or a mixture of polymers. Preferred polymers are cellulose or cellulose derivatives such as isopropylcellulose carboxymethylcellulose, cyanoethylcellulose or cellulose acetate. Particularly preferred cellulose products for use as the matrix material include Cellophane®, Cuprophan®, Hemophan, Ultranier, Placetate or Linters.

Examples of other suitable polymers include polysaccharides such as carrageenan, tragacanth gum, pectin, pullulan, xanthan gum, amylose or agarose; polyethylene glycol and polyethylene glycol derivatives; polyvinylalcohol; polyacrylamides such as polyacrylamide, poly(N-isopropylacrylamide), or polymethacrylamide; polyacrylic acids and esters thereof such as polyacrylic acid, poly(methacrylic acid), poly(itaconic acid) or polyhydroxyethylmethacrylate; hydrophilic polyurethanes; polyvinylpyrrolidone; polystyrene sulfonic acid; poly(3-morpholinylethylene); poly(N-1,2,4-triazolylethylene); polyvinyl sulfate; polyvinyl amine; poly(γ-glutamic acid); poly(2-ethyl-2-oxazoline); or poly(4-amino-3-sulfoaniline). Some of these polymers are water-soluble and should be subjected to cross-linking reactions before use as matrix materials, in a manner known per se.

The term “analyte” is intended to indicate a parameter, compound or composition to be detected. The analyte is generally a hydrophilic analyte for detection by senors with hydrophilic matrices. Examples of analytes which may favourably be determined by means of the sensor of the invention include

pH;

concentrations of electrolytes such as Li⁺, Na⁺, K⁺, Ca²⁺, Mg²⁺, Cl⁻, HCO₃⁻ or NH₃ (NH₄⁺);

concentrations of metabolic factors such as glucose, creatinine, urea (BUN), uric acid, lactic acid, pyruvic acid, ascorbic acid, phosphate or protein;

concentrations of enzymes such as lactic add dehydrogenase, lipase, amylase, choline esterase, alkaline phosphatase, acid phosphatase, alanine amino transferase, aspartate amino transferase or creatinine kinase.

The biological sample tested for the presence of the analyte is preferably a physiological fluid such as diluted or undiluted whole blood, serum, plasma, saliva, urine, cerebrospinal fluid, synovial fluid, milk, ascites fluid, peritoneal fluid or amniotic fluid. The sample may be treated prior to testing in order to make it more amenable to being tested. Preteatment methods may include dilution, filtration, concentration, extraction, removal or inactivation of components which might interfere with the results, and addition of reagents. Examples of other biological samples include fermentation broths or microbial cultures, waste water, food products, and the like.

Most indicator compounds for use in optical sensors are organic compounds that due to predominantly hydrophobic properties tend to form aggregates (e.g. dimers and higher aggregates) in the presence of moisture when included in a hydrophilic or water-swellable matrix. The indicator compound may be a light-absorbent or light-emitting (i.e. luminescent) dye. Luminescent dyes may be fluorescent, phosphorescent or chemiluminescent dyes.

The dye may suitably be selected from the group consisting of azo/hydrazone dyes, xanthenes, thioxanthenes, rhodamines, porphyrins, polymethines, e.g. cyanines, coumarines, indoanilines and anthraquinones. In each case, the indicator compound should be selected so as to be appropriate for the individual type of analyte to be determined. A list of indicators which might be of use for detecting specific analytes appears from E. Koller and O. S. Wolfbeis, “Sensor Chemistry”, in Fiber Optic Chemical Sensors and Biosensors, Vol 1, O. S. Wolfbeis (Ed.), CRC Press, 1991, pp. 303-350. Currently preferred dyes for the present purpose, in particular for incorporation into a pH sensor, are azo dyes, for instance 1-hydroxy-4-(2-nitro-4-(2-hydrogensulftoethyl)phenylazo)naphthalene (available from Merck, Darmstadt, Germany, under the trade name N-9).

As indicated above, the cyclic compound associated with the indicator compound is one which has a three-dimensional structure forming a hydrophobic inner cavity and a hydrophilic exterior surface. Without wishing to be limited to any particular theory, it is assumed that a hydrophobic moiety of the indicator compound is hosted by the hydrophobic cavity of the cyclic compound while leaving at least one functional group exposed for reaction with the analyte. The attachment of the cyclic compound serves to maintain the indicator compound in a monomeric state in the presence of moisture whereby the indicator compound remains evenly distributed in the analyte-sensitive portion of the matrix. The hydrophilic exterior surface of the cyclic compound is, on the other hand, compatible with the hydrophilic matrix material as well as with the water taken up by the matrix from the ambient moisture. Examples of cyclic compounds which can have the desired properties are cyclodextrins, modified calixarenes, cyclic peptides, carcerands, cryptophanes or cyclophanes, including azacyclophanes.

Particularly preferred cyclodextrins for binding to the indicator compound are selected from the group consisting of α-cydodextrin, β-cyclodextrin, γ-cyclodextin, hydroxyalkyl substituted cyclodextrin, e.g. hydroxyethyl or hydroxypropyl substituted cyclodextrin, alkyl substituted cyclodextrin, e.g. methyl substituted cyclodextin, and cyclodextrin substituted with reactive/functional groups, e.g. monochlorotriazin-β-cyclodextrin (e.g. BETA W7 Hct from Wacker). It should be noted that β-cyclodextrin which is sparingly soluble in itself may be rendered more suitable for attachment to the indicator compound by appropriate substitution, e.g. with hydroxypropyl groups.

The use of calixarenes as indicator compounds in optical ion-selective electrodes is described in WO 95/00473. It has been found that calixarenes generally have a three-dimensional structure which is the opposite of that of cyclodextrin, i.e. the inner cavity is predominantly hydrophilic, and the exterior surface is predominantly hydrophobic. it is, however, envisaged that the calixarenes disclosed in WO 95/00473 may be used to stabilise hydrophobic indicator compounds immobilised in a hydrophilic matrix if they are suitably modified. Suitable modifications may for instance include substitution of hydroxy groups on the calixarene ring by groups imparting hydrophobicity to the interior of the calixarene structure and, conversely, substitution, e.g. of the ring carbons, by groups imparting hydrophilicity to the exterior of the calixarene ring.

Carcerands, cryptophanes, cyclophanes and azacyclophanes are described in, e.g., H.-J. Schneider and H. Dürr, Frontiers in Supramolecular Organic Chemistry and Photochemistry, VCH Verlagsgesellschaft, Weinheim, Germany, 1991.

The immobilisation of the indicator compound to the matrix material and modification of the matrix to comprise a cyclic compound attached to the indicator compound may be accomplished in various ways. In general, the preparation of suitable matrices may follow the methods described in E. Koller and O. S. Wolfbeis, “Sensor Chemistry”, in Fiber Optic Chemical Sensors and Biosensors, Vol 1, O. S. Wolfbeis (Ed.), CRC Press, 1991, pp. 303-350, including mechanical, electrostatic and chemical immobilisation. For the present purpose, chemical immobilisation is generally most suitable.

More specifically, the attachment of the cyclic compound may be performed by immersing the matrix material containing the indicator compound immobilised in the matrix material in an aqueous solution of the cyclic compound for a sufficient period of time to effect association of the cyclic compound with the indicator compound.

Alternatively, the cyclic compound may be added to the matrix material comprising the indicator compound prior to distribution of the matrix material in the appropriate part of the sensor, or prior to the formation of a layer or membrane of matrix material.

In a further alternative, the cyclic compound may be immobilised in the matrix material followed by association of the indicator compound with the cyclic compound. This procedure may be accomplished, e.g. by immersion of the matrix material comprising the immobilised cyclic compound in a solution of the indicator compound for a sufficient period of time to effect association of the indicator compound with the cyclic compound.

The present invention further relates to the use of a cyclic compound which has a three dimensional shape forming a hydrophobic inner cavity and a hydrophilic exterior surface to protect a hydrophobic analyte-sensitive indicator compound from aggregation in the presence of moisture in a hydrophilic and/or water-swellable polymeric matrix material.

When a membrane of a hydrophilic material is modified to include a hydrophobic indicator compound either incorporated in the bulk of the matrix material or immobilised on its surface, this may have profound consequences for the wettability of the membrane and hence its contact with an aqueous biological sample such as a physiological fluid. It has surprisingly been found that when a cyclic compound as described above is associated with a hydrophobic indicator compound, the wettability of the membrane may be improved. The invention therefore also relates to the use of a cyclic compound which has a three-dimensional shape forming a hydrophobic inner cavity and a hydrophilic exterior surface to improve the wettability of a hydrophilic and/or water-swellable matrix material which includes a hydrophilic analyte-sensitive indicator-compound.

In particular cellulose membranes for use in the sensor according to the invention tend to become brittle when in the dry state. This brittleness makes the membrane material more difficult to handle both in the preparation of the sensors and when they are subsequently in use. An added advantage of incorporating a cyclic compound such as cyclodextin is that it may serve to soften the membrane to make it less brittle.

The invention is further described in the following example which is not in any way intended to limit the scope of the invention as claimed.

### EXAMPLE

Preparation of a cellulose membrane with an immobilised indicator compound and cyclodextrin bound to the indicator compound

The preparation of the membrane with immobilised indicator compound was performed substantially as described in U.S. Pat. No. 5,288,646 with the exception that Cuprophan® 8 μm, available from Akzo, the Netherlands, was used as membrane material instead of Cellophane. First a solution of an indicator compound consisting of 9.66 g (assuming a dye content of 100%) of 1-hydroxy-4-(2-nitro-4-(2-hydrogensulftoethyl)phenylazo)naphthalene (available from Merck, Darmstadt, Germany, under the trade name N-9) per 500 ml DMSO solution was prepared. The DMSO solution was subsequently mixed in the ration 1:100 with an aqueous solution of 63 g NaOH and 2365 g Na₂SO₄ per 25 L H₂O at ambient temperature. The Cuprophane membrane was immersed in this solution which contains 1% DMSO and has a pH of approx. 12.3. The membrane was left in the indicator solution until an optical density at 458 nm at pH 4-6 was 1.00±0.05. The total contact time necessary is approximately 25 minutes. Then the membrane was removed from the indicator solution and rinsed with a solution of 35 g NaOH per 25 L H₂O followed by a rinsing with deionised H₂O.

A solution was prepared of 20 g/l hydroxypropyl-β-cyclodextrin (BETA W7 HP, available from Wacker, Germany) in deionised water. The membrane containing the immobilised indicator compound was immersed in this solution for 8 minutes. The membrane was subsequently dried and stored under ambient conditions before use.

1. An optical sensor for measuring an analyte in a biological sample, the sensor comprising a hydrophilic and/or water-swellable polymeric matrix material at least one portion of which includes an analyte-sensitive indicator compound and a cyclic compound which has a three-dimensional structure forming a hydrophobic inner cavity and a hydrophilic exterior surface.

2. An optical sensor according to claim 1, wherein the indicator compound is immobilised in the matrix, and wherein the cyclic compound is associated with the indicator compound.

3. An optical sensor according to claim 1, wherein the cyclic compound is immobilised in the matrix, and wherein, the indicator compound is associated with the cyclic compound.

4. An optical sensor according to any of claims 1-3 comprising a layer of the matrix material.

5. An optical sensor according to claim 4, wherein the layer of the matrix material constitutes or is incorporated in a membrane of the sensor.

6. An optical sensor according to claim 1, wherein the polymeric matrix material is selected from the group consisting of cellulose and cellulose derivatives such as isopropylcellulose, carboxymethylcellulose, cyanoethylcellulose or cellulose acetate; a polysaccharide such as carrageenan, tragacanth gum, pectin, pullulan, xanthan gum, amylose or agarose; polyethylene glycol and polyethylene glycol derivatives; polyvinylalcohol; polyacrylamides such as polyacrylamide, poly(N-isopropylacrylamide), or polymethacrylamide; polyacrylic acids and esters thereof such as polyacrylic acid, poly(methacrylic acid), poly(itaconic acid) or polyhydroxyethylmethacrylate; hydrophilic polyurethanes; polyvinylpyrrolidone; polystyrene sulfonic acid; poly(3-morpholinylethylene); poly(N-1,2,4-triazolylethylene); polyvinyl sulfate; polyvinyl amine; poly(γ-glutamic acid); poly(2-ethyl-2-oxazoline); or poly(4-amino-3-sulfoaniline).

7. An optical sensor according to claim 5, wherein the membrane has a thickness in the range of 1-50 μm, such as 5-20 μm, in particular about 8 μm.

8. An optical sensor according to any of claims 1-7 which is adapted to measure one or more analytes in the biological sample, such as pH, concentrations of electrolytes, concentrations of metabolic factors or concentrations of enzymes.

9. An optical sensor according to claim 1, wherein the indicator compound is a hydrophobic, organic compound.

10. An optical sensor according to claim 9, wherein the indicator compound is a light-absorbing or luminescent dye.

11. An optical sensor according to claim 10, wherein the luminescent dye is a fluorescent, phosphorescent or chemiluminescent dye.

12. An optical sensor according to claim 10 or 11, wherein the dye is selected from the group consisting of azo/hydrazone dyes, xanthenes, thioxanthenes, rhodamines, porphyrins, polymethines, e.g. cyanines, coumarines, indoanilines and anthraquinones.

13. An optical sensor according to claim 1, wherein the cyclic compound is a cyclodextrin, a modified calixarene, a cyclic peptide, a carcerand, a cryptophane or a cyclophane, including an azacyclophane.

14. An optical sensor according to claim 13, wherein the cyclodextrin is selected from the group consisting of α-cyclodextrin, β-cyclodextrin, γ-cyclodextrin, hydroxyalkyl substituted cyclodextrin, e.g. hydroxyethyl or hydroxypropyl substituted cyclodextrin, alkyl Substituted cyclodextrin, e.g. methyl substituted cyclodextrin, and cyclodextrin substituted with reactive/functional groups, e.g. monochlorotriazine-β-cyclodextrin.

15. A membrane adapted for use in an optical sensor for measuring an analyte in a biological sample, the membrane comprising a hydrophilic and/or water-swellable polymeric matrix material which at least in one portion includes an analyte-sensitive indicator compound and a cyclic compound which has a three-dimensional structure forming a hydrophobic inner cavity and a hydrophilic exterior surface.

16. A membrane according to claim 15, wherein the indicator compound is immobilised in the matrix, and wherein the cyclic compound is associated with the indicator compound.

17. A membrane according to claim 15, wherein the cyclic compound is immobilised in the matrix, and wherein the indicator compound is associated with the cyclic compound.

18. A membrane according to any of claims 15-17, wherein the cyclic compound is a cyclodextrin, a modified calixarene, a cyclic peptide, a carcerand, a cryptophane or a cyclophane, including an azacyclophane.

19. A membrane according to claim 18, wherein the cyclodextrin is selected from the group consisting of α-cyclodextrin, β-cyclodextrin, γ-cyclodextrin, hydroxyalkyl substituted cyclodextrin, e.g. hydroxyethyl or hydroxypropyl substituted cyclodextrin, alkyl substituted cyclodextrin, e.g. methyl substituted cyclodextrin, and cyclodextrin substituted with reactive/functional groups, e.g. monochlorotriazine-β-cyclodextrin.

20. A membrane according to claim 15, wherein the polymeric matrix material is selected from the group consisting of cellulose and cellulose derivatives such as isopropylcellulose, carboxymethylcellulose, cyanoethylcellulose or cellulose acetate; a polysaccharide such as carrageenan, tragacanth gum, pectin, pullulan, xanthan gum, amylose or agarose; polyethylene glycol and polyethylene glycol derivatives; polyvinylalcohol; polyvinylpyrrolodone; polyacrylamides such as polyacrylamide, poly(N-isopropylacrylamide), or polymethacrylamide; polyacrylic acids and esters thereof such as polyacrylic acid, poly(methacrylic acid), poly(itaconic acid) or polyhydroxyethylmethacrylate; hydrophilic polyurethanes; polystyrene sulfonic acid; poly(3-morpholinylethylene); poly(N-1,2,4-triazolylethylene); polyvinyl sulfate; polyvinyl amine; poly(γ-glutamic acid); poly(2-ethyl-2-oxazoline); or poly(4-amino-3-sulfoaniline).

21. A membrane according to claim 15 which has a thickness in the range of 1-50 μm, such as 5-20 μm, in particular about 8 μm.

22. A membrane according to any of claims 15-21 which is adapted for use in an optical sensor intended to measure one or more parameters in the biological sample, such as pH, concentrations of electrolytes, concentrations of metabolic factors or concentrations of enzymes.

23. A membrane according to claim 15, wherein the indicator compound is a hydrophobic, organic compound.

24. A membrane according to claim 23, wherein the indicator compound is a light-absorbent or luminescent dye.

25. A membrane according to claim 24, wherein the luminescent dye is a fluorescent, phosphorescent or chemiluminescent dye.

26. A membrane according to claim 24 or 25, wherein the dye is selected from the group consisting of azo/hydrazone dyes, xanthenes, thioxanthenes, rhodamines, porphyrins, polymethines, e.g. cyanines, coumarines, indoanilines and anthraquinones.

27. A method of improving the properties of a membrane for use in an optical sensor, the membrane comprising a hydrophilic and/or water-swellable polymeric matrix material at least one portion of which includes an analyte-sensitive indicator compound, the method comprising contacting the indicator compound with a cyclic compound which has a three-dimensional structure forming a hydrophobic inner cavity and a hydrophilic exterior surface for a sufficient period of time to form an association of the indicator compound with the cyclic compound.

28. A method according to claim 27, wherein the cyclic compound is a cyclodextrin, a modified calixarene, a cyclic peptide, a carcerand, a cryptophane or a cyclophane, including an azacyclophane.

29. A method according to claim 28, wherein the cyclodextrin is selected from the group consisting of α-cyclodextrin, β-cyclodextrin. γ-cyclodextrin, hydroxyalkyl substituted cyclodextrin, e.g. hydroxyethyl or hydroxypropyl substituted cyclodextrin, alkyl substituted cyclodextrin, e.g. methyl substituted cyclodextrin, and cyclodextrin substituted with reactive/functional groups, e.g. monochlorotriazine-β-cyclodextrin.

30. A method according to claim 27, wherein the indicator compound is immobilised in the matrix material, and the matrix material is subsequently immersed in an aqueous solution of the cyclic compound for a sufficient period of time to effect association of the cyclic compound with the indicator compound.

31. A method according to claim 27, wherein the cyclic compound is added to the matrix material comprising the indicator compound prior to preparing the membrane from the matrix material.

32. A method according to claim 27, wherein the cyclic compound is immobilised in the matrix material followed by association of the indicator compound with the cyclic compound.

33. A method according to claim 27, wherein the indicator compound is a hydrophobic, organic compound.

34. A method according to claim 33, wherein the indicator compound is a light-absorbing or luminescent dye.

35. A method according to claim 34, wherein the luminescent dye is a fluorescent, phosphorescent or chemiluminescent dye.

36. A method according to claim 34 or 35, wherein the dye is selected from the group consisting of azo/hydrazone dyes, xanthenes, thioxanthenes, rhodamines, porphyrins, polymethines, e.g. cyanines, coumarines, indoanilines and anthraquinones.

37. A method according to claim 27, wherein the polymeric matrix material is selected from the group consisting of cellulose and cellulose derivatives such as isopropylcellulose, carboxymethylcellulose, cyanoethylcellulose or cellulose acetate; a polysaccharide such as carrageenan, tragacanth gum, pectin, pullulan, xanthan gum, amylose or agarose; polyethylene glycol and polyethylene glycol derivatives; polyv nylalcohol; polyvinylpyrrolidone; polyacrylamides such as polyacrylamide, poly(N-isopropylacrylamide), or polymethacrylamide; polyacrylic acids and esters thereof such as polyacrylic acid, poly(methacrylic acid), poly(itaconic acid) or polyhydroxyethylmethacrylate; hydrophilic polyurethanes; polystyrene sulforic acid; poly(3-morpholinylethylene); poly(N-1,2,4-triazolylethylene); polyvinyl sulfate; polyvinyl amine; poly(γ-glutamic acid): poly(2-ethyl-2-oxazoline); or poly(4-amino-3-sulfoaniline).

38. Use of a cyclic compound which has a three-dimensional shape forming a hydrophobic inner cavity and a hydrophilic exterior surface to protect a hydrophobic analyte-sensitive indicator compound in a hydrophilic and/or water-swellable polymeric matrix material of an optical sensor from aggregation in the presence of moisture.

39. Use of a cyclic compound which has a three-dimensional shape forming a hydrophobic inner cavity and a hydrophilic exterior surface to increase the wettability and reduce the brittleness of a hydrophilic and/or water-swellable polymeric matrix material of an optical sensor, which polymeric matrix material includes a hydrophobic analyte-sensitive indicator compound.
